(19) United States
(12) Patent Application Publication
(10) Pub. No.: US 2010/0075537 A1
(43) Pub. Date: Mar. 25, 2010

(54) CONNECTOR FOR TERMINATING A RIBBON CABLE

(76) Inventors: James F. McIntire, West Linn, OR (US); Brian Erik Haug, Portland, OR (US)

Correspondence Address: Marguerite E. Gerstner;Tyco Electronics Corporation, Intellectual Property Law Department, 309 Constitution Drive, M/S R34/2A, Menlo Park, CA, 94025-1164, US

(21) Appl. No.: 12/236,351

(22) Filed: Sep. 23, 2008

(51) Int. Cl. H01R 13/40

(52) U.S. Cl. 439/626

(57) ABSTRACT

A connector is provided for terminating a ribbon cable having a plurality of electrical leads. Each electrical lead includes a mating portion. The connector includes a housing having a wall and a cavity. The housing is configured to hold the mating portion of each electrical lead within the cavity. The housing includes a hole extending through the wall of the housing and communicating with the cavity. The hole exposes the mating portion of at least one electrical lead through the wall.

### BACKGROUND OF THE INVENTION

The subject matter described and illustrated herein relates generally to ribbon cables, and more particularly, to a connector for terminating a ribbon cable.

Ribbon cables are often used to interconnect two electronic devices. For example, ribbon cables may be used to electrically connect a group of electrodes to an electronic monitoring or stimulating device. Ribbon cables include a plurality of electrical leads that electrically interconnect the two electronic devices. Each electrical lead includes an electrical conductor that is surrounded by an electrically insulative jacket. The electrical leads may sometimes be shielded using other electrically conductive and electrically insulative layers between the electrical conductor and the electrically insulative jacket. The electrically insulative jackets of adjacent ones of the electrical leads are connected together to form the body of the ribbon cable, which typically has an approximately planar shape.

To electrically connect the ribbon cable to an electronic device, an end portion of the ribbon cable is typically terminated to a connector that mates with another connector of the electronic device. The connector terminated to the ribbon cable includes electrical contacts that engage corresponding electrical contacts of the other connector of the electronic device. Each electrical contact of the connector terminated to the ribbon cable is electrically connected to the corresponding electrical lead, or more specifically the corresponding electrical conductor, of the ribbon cable using conventional methods, such as by welding, soldering, or crimping the electrical contacts to the corresponding electrical conductor. However, terminating the electrical contacts to the electrical conductors may increase the cost and/or difficulty of manufacturing the connector, assembling the connector, and/or terminating the connector to the ribbon cable. Moreover, the electrical contacts of the connector that terminates the ribbon cable may increase a size and/or a complexity of the connector and therefore may increase the cost and/or difficulty of manufacturing the connector, assembling the connector, and/or terminating the connector to the ribbon cable.

There is a need for a connector that is less costly and/or more easily manufactured, assembled, and/or terminated to a ribbon cable than at least some known connectors.

### BRIEF DESCRIPTION OF THE INVENTION

In one embodiment, a connector is provided for terminating a ribbon cable having a plurality of electrical leads. Each electrical lead includes a mating portion. The connector includes a housing having a wall and a cavity. The housing is configured to hold the mating portion of each electrical lead within the cavity. The housing includes a hole extending through the wall of the housing and communicating with the cavity. The hole exposes the mating portion of at least one electrical lead through the wall.

In another embodiment a connector is provided for mating with another connector that terminates a ribbon cable, wherein the ribbon cable has a plurality of electrical leads. Each electrical lead includes a mating portion. The connector includes a housing having a cavity configured to receive at least a portion of the other connector therein. The housing holds a plurality of electrical contacts within the cavity. The electrical contacts are each configured to directly engage a corresponding one of the mating portions of the electrical leads when the connector is mated with the other connector.

In another embodiment, a connector assembly is provided that includes a ribbon cable having a plurality of electrical leads. Each of the electrical leads includes a mating portion. The connector assembly also includes a first connector including a first housing having a wall and a cavity. The first housing holds the mating portion of each electrical lead within the cavity. The first housing includes a hole extending through the wall of the first housing and communicating with the cavity. The hole exposes the mating portion of at least one electrical lead through the wall. The connector assembly also includes a second connector mated together with the first connector and includes a second housing holding a plurality of electrical contacts. Each of the mating portions of the electrical leads is directly engaged with a corresponding one of the electrical contacts of the second connector.

### BRIEF DESCRIPTION OF THE DRAWINGS

FIG. 1 is a perspective view of an exemplary embodiment of a ribbon cable.

FIG. 2 is a cross-sectional view of the ribbon cable shown in FIG. 1 taken along line 2-2 of FIG. 1.

FIG. 3 is a perspective view of an exemplary embodiment of a connector assembly for use with the ribbon cable shown in FIGS. 1 and 2.

FIG. 4 is another perspective view of the connector assembly shown in FIG. 3.

FIG. 5 is an exploded perspective view of a connector of the connector assembly shown in FIGS. 3 and 4.

FIG. 6 is a perspective view of a portion of the connector assembly shown in FIGS. 3 and 4 illustrating assembly thereof.

FIG. 7 is another perspective view of a portion of the connector assembly shown in FIGS. 3 and 4 illustrating assembly thereof.

FIG. 8 is an exploded perspective view of an exemplary embodiment of a connector that is configured to be mated with the connector assembly shown in FIGS. 3 and 4.

FIG. 9 is a partially broken-away perspective view of a connector assembly illustrating the connector shown in FIG. 8 mated together with the connector assembly shown in FIGS. 3 and 4.

### DETAILED DESCRIPTION OF THE INVENTION

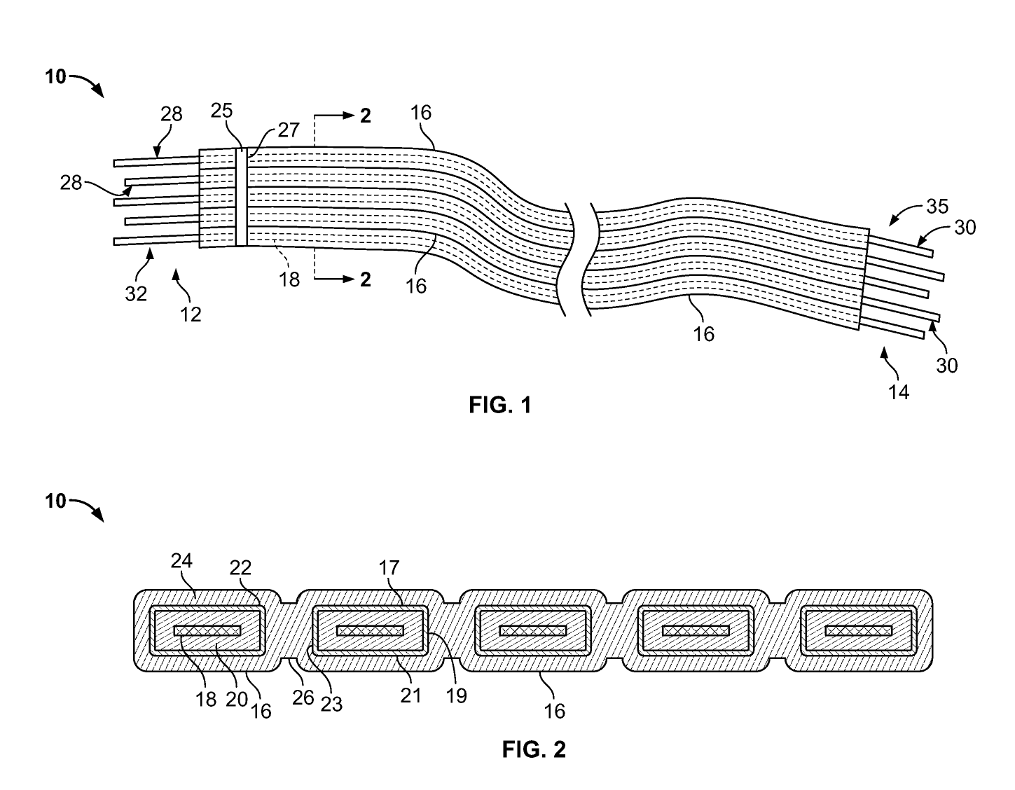

FIG. 1 is a perspective view of an exemplary embodiment of a ribbon cable 10. FIG. 2 is a cross-sectional view of the ribbon cable 10 taken along line 2-2 of FIG. 1. The ribbon cable 10 extends a length between a pair of opposite mating end portions 12 and 14. The ribbon cable 10 includes a plurality of electrical leads 16 that each extend along the length of the ribbon cable 10 from the mating end portion 12 to the mating end portion 14. Each electrical lead 16 includes an electrical conductor 18 that extends along the length of the ribbon cable 10 from the mating end portion 12 to the mating end portion 14.

In the exemplary embodiment, each of the electrical conductors 18 is shielded along a portion of the length thereof. The electrical conductors 18 may be shielded using any suitable arrangement, configuration, structure, means, and/or the like, for example, but not limited to, as shown in FIG. 2. Specifically, in the exemplary embodiment, each electrical conductor 18 is at least partially surrounded by any suitable electrically insulative material(s) 20. The electrically insulative material 20 is at least partially surrounded by any suitable electrically conductive material 22, which is at least partially surrounded by any suitable electrically insulative jacket 24. Although the electrically conductive material 22 is shown in FIG. 2 as completely surrounding the corresponding electrically insulative material 20 and the corresponding electrical conductor 18, the electrically conductive material 22 may only partially surround the corresponding electrically insulative material and the corresponding electrical conductor 18. For example, the electrically conductive material 22 may optionally only include some of the side portions 17, 19, 21, and 23 thereof. In such a case wherein the electrically conductive material only partially surrounds the corresponding electrically insulative material 20 and the corresponding electrical conductor 18, the electrically insulative jacket 24 and the electrically insulative material 20 may optionally be formed integrally (i.e., may optionally not be separate components). In the exemplary embodiment, the electrically conductive materials 22 of the electrical leads 16 are electrically connected together via a ground strap 25 that engages each of the electrically conductive materials 22 through one or more openings 27 within the electrically insulative jacket 24. In embodiments wherein the electrically conductive material 22 of an electrical lead 16 includes two or more separate portions that are not connected together (e.g., if the electrically conductive material 22 only includes the side portions 17 and 21), the ground strap 25 may extend around the ribbon cable 10 such that the ground strap 25 is electrically connected to each of the separate portions (through one or more openings).

In alternative embodiments, the electrical leads 16 are not shielded, but instead the electrical conductor 18 is at least partially surrounded by the electrically insulative jacket 24 without having the electrically insulative material 20 or the electrically conductive material 22 disposed between the electrically insulative jacket 24 and the electrical conductor 18.

As is best seen in FIG. 2, the electrically insulative jacket 24 of each electrical lead 16 is connected to the electrically insulative jacket 24 of each adjacent electrical lead 16 such that the electrical leads 16 are connected together to form the ribbon cable 10. The connection points between the electrically insulative jackets 24 are identified herein by the reference numeral 26. In some embodiments, the ribbon cable 10 is separable (such as, but not limited to, using perforations and/or the like) at the connection points 26 along at least a portion of the length of the ribbon cable 10 such that some or all of the electrical leads 16 may be at least partially separated from adjacent electrical leads 16.

Each of the electrically insulative material 20, the electrically conductive material 22, and the electrically insulative jacket 24 extend along the length of the corresponding electrical lead 16 between the mating end portions 12 and 14. As can be seen in FIG. 1, mating portions 28 and 30 of each of the electrical conductors 18 are exposed from the electrically insulative material 20, the electrically conductive material 22, and the electrically insulative jacket 24 at the mating end portions 12 and 14, respectively, of the ribbon cable 10. The mating portions 28 and 30 are each configured to be electrically connected to electronic devices to electrically interconnect the electronic devices via the ribbon cable 10. In the exemplary embodiment, end portions 32 and 35 of the electrical conductors 18 include the respective mating portions 28 and 30. Alternatively, one or more of the mating portions 28 and/or 30 extend along another portion of the corresponding electrical conductor 18 than the respective end portion 32 or 35.

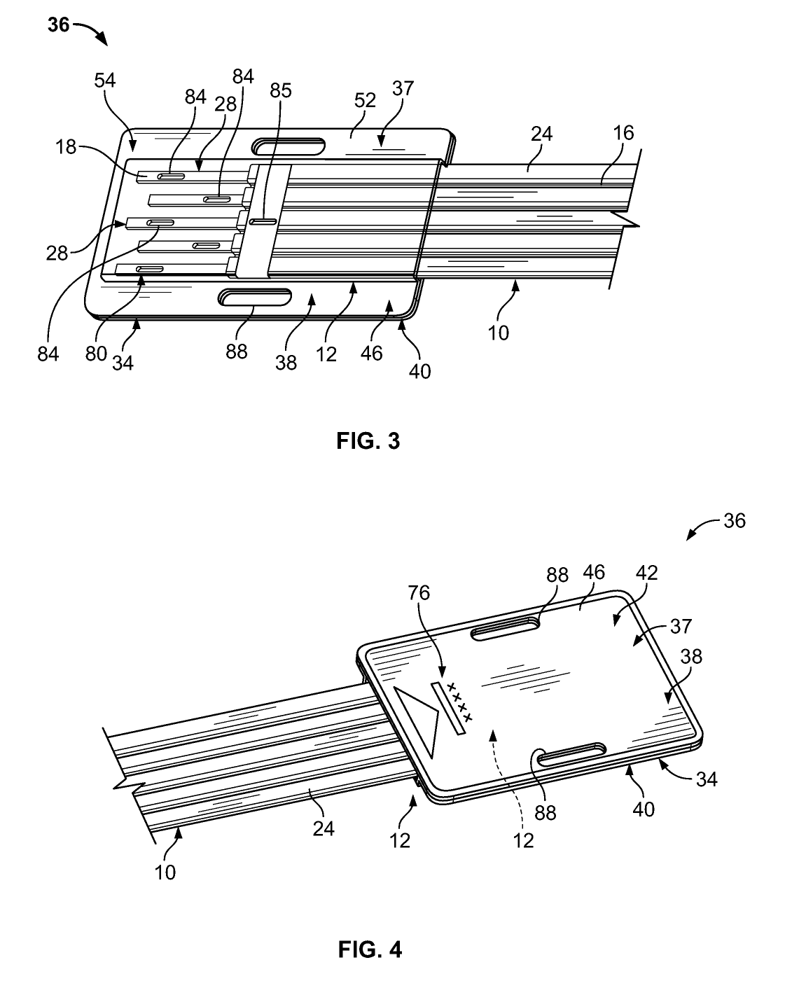

As will be described below, a connector 34 (FIGS. 3-7 and 9) is provided for electrically connecting the electrical leads 16, and more specifically the electrical conductors 18, to another electronic device at one of the mating end portions 12 or 14. The ribbon cable 10 may electrically interconnect any type of electronic devices to each other, whether or not the interconnected electronic devices are of the same type. For example, the ribbon cable may electrically connect a plurality of electrodes (not shown) to another electronic device that reads electrical signals from and/or delivers electrical signals to the electrodes, such as, but not limited to, an electrical stimulating device (not shown) and/or an electrical monitoring device (not shown; such as, but not limited to, an electrocardiogram (ECG) monitoring device, a hand-held system monitor, and/or the like), and/or the like. Although five are shown, the ribbon cable 10 may include any number of electrical leads 16 for providing any number of electrical paths between the two electronic devices that are electrically connected via the ribbon cable 10.

The electrical conductors 18 may each be fabricated from any suitable electrically conductive material(s) that enables the electrical conductors 18 to electrically connect the two electronic devices, such as, but not limited to, silver, aluminum, gold, copper, other metallic conductors, non-metallic conductors (such as, but not limited to, carbon and/or the like), and/or the like. The electrical conductors 18 may also have any suitable configuration, geometry, size, shape, and/or the like that enables the electrical conductors 18 to electrically connect the two electronic devices, such as, but not limited to, a cylindrical electrically conductive wire (such as, but not limited to, a stranded wire and/or the like), an approximately planar shape, and/or the like. As is best seen in FIG. 2, in the exemplary embodiment, the electrical conductors 18 have an approximately planar shape.

The electrically conductive material 22 may be fabricated from any suitable electrically conductive material(s) that facilitates shielding the electrical conductors 18 and/or enables the ribbon cable 10 to function as described herein, such as, but not limited to, silver, aluminum, gold, copper, other metallic conductors, non-metallic conductors (such as, but not limited to, carbon and/or the like), electrically conductive inks, other electrically conductive coatings, and/or the like.

The electrically insulative material 20 may be fabricated from any suitable electrically insulative material(s) that facilitates insulating and/or shielding the electrical conductors 18 and/or that enables the ribbon cable 10 to function as described herein, such as, but not limited to, polyester (e.g., Mylar(t), polyvinyl chloride, polyethylene, Electrodag® 1015 (commercially available from Acheson Colloids Company of Port Huron, Mich.), thermo-plastic-elastomer, polyimide (e.g., Kapton®), and/or the like.

The electrically insulative jacket 24 may be fabricated from any suitable electrically insulative material(s) that facilitates insulating and/or shielding the electrical conductors 18 and/or that enables the ribbon cable 10 to function as described herein, such as, but not limited to, polyester (e.g., Mylar®), polyvinyl chloride, polyethylene, Electrodag® 1015 (commercially available from Acheson Colloids Company of Port Huron, Mich.), thermo-plastic-elastomer, polyimide (e.g., Kapton®), and/or the like. The electrically insulative materials 20, the electrically conductive materials 22, and the electrically insulative jacket 24 may each have other cross-sectional shapes than the shapes shown in FIG. 2 if the electrical conductors are formed with a different cross-sectional shape than the shape shown in FIG. 2.

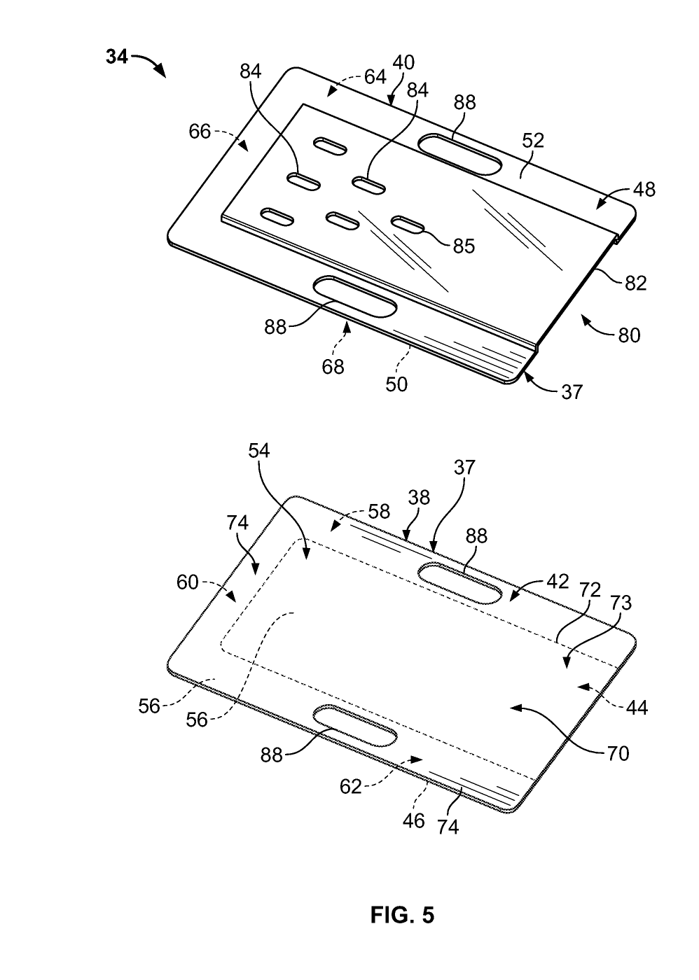

FIGS. 3 and 4 are perspective views of an exemplary embodiment of a connector assembly 36 for use with the ribbon cable 10. FIG. 5 is an exploded perspective view of the connector 34. The connector assembly 36 includes the connector 34 and the ribbon cable 10. Specifically, the ribbon cable 10 is connected, or terminated, to the connector 34. The connector 34 may be referred to herein as a “first connector”. As described above, the connector 34 enables the ribbon cable 10 to be electrically connected to another electronic device. In the exemplary embodiment, the end portion 12 of the ribbon cable 10 is connected to the connector 34. Alternatively, the end portion 14 (FIG. 1) of the ribbon cable 10 may be connected to the connector 34. Moreover, in some embodiments the end portion 12 is connected to the connector 34 and the end portion 14 is connected to another of the connector 34. Connection of the ribbon cable 10 to the connector 34 will be described herein only with regard to the end portion 12 of the ribbon cable 10. It should be understood that description of the connection between the end portion 12 and the connector 34 is also applicable, and substantially identical, to connection between the end portion 14 of the ribbon cable 10 and the connector 34.

The connector 34 includes a dielectric housing 37 that includes a housing component 38 and a housing component 40 that is connectable to the housing component 38 such that the mating portions 28 of the electrical conductors 18 are held between the housing component 40 and the housing component 38, as will be described below. The housing components 38 and 40 may each be referred to herein as a “first housing component” and/or a “second housing component”. The housing component 38 includes a body 42 having a pair of opposite surfaces 44 and 46. The housing component 40 includes a body 48 having a pair of opposite surfaces 50 and 52. When the housing component 40 is connected to the housing component 38, the respective surfaces 44 and 50 of the housing component 38 and the housing component 40 face each other. The surface 44 of the housing component 38 includes a lead retention area 54 along which the mating portions 28 of each of the electrical conductors 18 are arranged. In addition or alternative, the lead retention area 54 may be defined by a portion of the housing component 40. The lead retention area 54 may optionally include a fastener for holding the mating portions 28 on the lead retention area 54. In the exemplary embodiment, the fastener that holds the mating portions 28 on the lead retention area 54 is an adhesive 56 on the surface 44. However, any suitable fastener may be used to hold the mating portions 28 on the lead retention area 54. Examples of other suitable fasteners for holding the mating portions 28 on the lead retention area 54 include, but are not limited to, forming one or more grooves (not shown), within the surface 44 and along the lead retention area 54, that receive the mating portions 28 in an interference-fit arrangement. The adhesive 56 may be any suitable adhesive capable of holding the mating portions 28 on the lead retention area 54 such that the connector 34 functions as described and illustrated herein, such as, but not limited to, a self-adhering and/or pressure-sensitive adhesive (PSA) and/or the like. In addition or alternative to the adhesive 56 extending on the surface 44 along the lead retention area 54, the surface 50 of the housing component 40 may include any suitable fastener on a portion of the surface 50 that defines the lead retention area 54 to hold the mating portions 28 on the lead retention area 54.

The housing component 38 and/or the housing component 40 include a fastener for connecting the housing component 38 and the housing component 40 together as is shown in FIGS. 3 and 4. In the exemplary embodiment, the adhesive 56 described above defines a fastener for connecting the housing component 38 and the housing component 40. Specifically, in the exemplary embodiment, the adhesive 56 extends not only along the lead retention area 54 of the surface 44 but also extends along edge portions 58, 60, and 62 of the surface 44. When the housing component 40 is connected to the housing component 38 as shown in FIGS. 3 and 4, edge portions 64, 66, and 68 of the surface 50 engage and adhere to the adhesive 56 at the respective edge portions 58, 60, and 62 of the surface 44 to connect the housing component 38 and the housing component 40 together. In addition or alternative to the adhesive 56 extending along the edge portions 58, 60, and 62 of the surface 44, the edge portions 64, 66, and 68 of the housing component 40 may include adhesive (not shown). Moreover, the adhesive 56 may extend on only some of the edge portions 58, 60, and/or 62 of the surface 44 and/or adhesive may extend on only some of the edge portions 64, 66, and/or 68 of the surface 50. Further, in addition or alternative to the edge portions 58, 60, 62, 64, 66, and/or 68, the adhesive 56 may extend along one or more other portions of the surface 44, and/or adhesive may extend along one or more other portions of the surface 50, for connecting the housing component 40 and the housing component 38 together. For example, the optional portion of the adhesive 56 that extends along the lead retention area 54 may engage the surface 50, and/or the portion of the surface 50 that is aligned with the lead retention area 54 when the housing component 40 and the housing component 38 are connected together may include adhesive (not shown).

Other examples of fasteners for connecting the housing component 38 and the housing component 40 together include, but are not limited to, providing an interference-fit between portions of the housing component 38 and the housing component 40, providing the housing component 38 and the housing component 40 with latch components (not shown) that cooperate to connect the housing component 38 and the housing component 40 together, and/or the like.

As can be seen in FIG. 5, the housing component 38 may optionally include a removable liner 70 that covers at least a portion of the adhesive 56 on the surface 44. The liner 70 protects the adhesive 56 before the connector 34 is assembled and is removed from the surface 44 before assembling the connector 34. In the exemplary embodiment, the liner includes a perforation 72 that separates the liner into two different portions 73 and 74. As will be described below with reference to assembly of the connector 34, the portion 73 of the liner 70 can be removed before the portion 74 of the liner 70 is removed, or vice versa. If the surface 50 of the housing component 40 includes adhesive thereon, the surface 50 may optionally include a removable liner (not shown) that covers at least a portion of the adhesive.

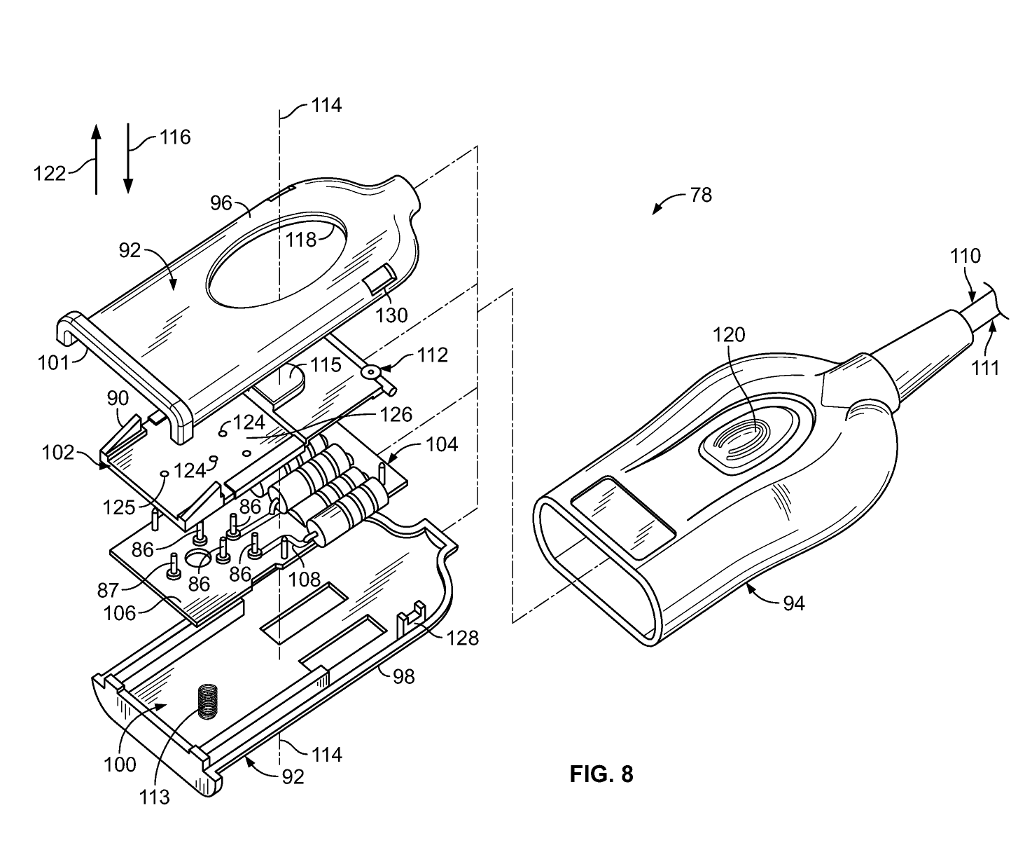

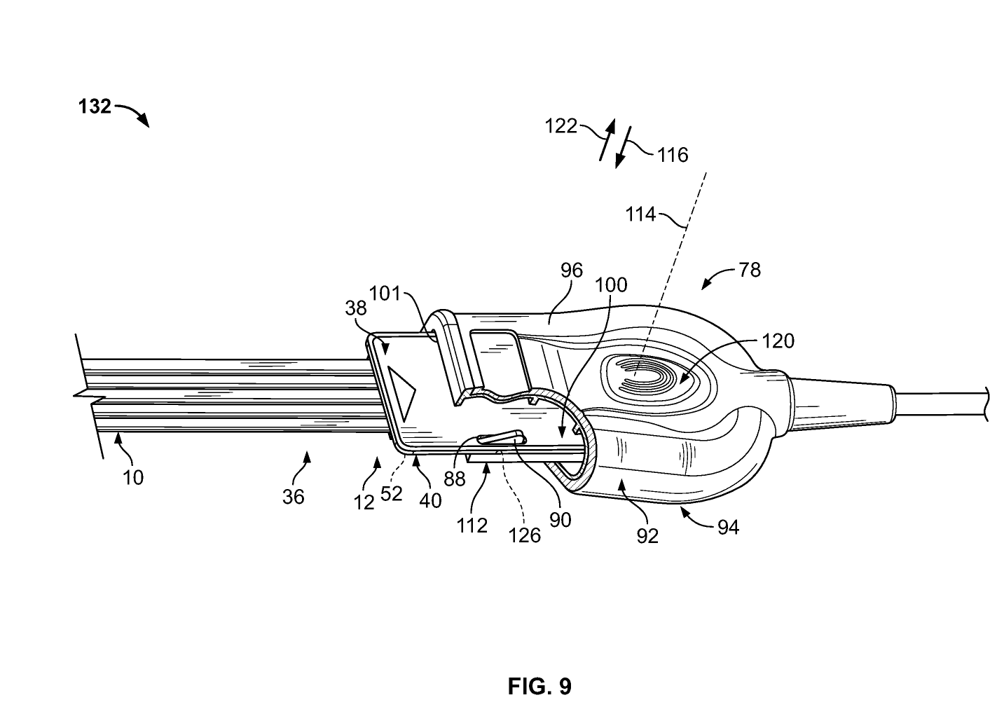

The surface 46 of the housing component 38 may optionally include indicia 76, as can be seen in FIG. 4. The indicia 76 may indicate any information, such as, but not limited to, a direction in which the connector 34 is to be mated with another connector (such as, but not limited to, the connector 78 shown in FIGS. 8 and 9), a part number of the connector 34 and/or connector assembly 36, a lot code of the connector 34 and/or the connector assembly 36, a company logo, a diagram of the location on a body that electrodes connected to the end portion 14 of the ribbon cable 10 are placed, and/or the like. In addition or alternative to the indicia 76 on the surface 46, the surface 52 of the housing component 40 and/or other portions and/or surfaces of the connector 34 may optionally include indicia thereon.

When the housing component 38 and the housing component 40 are connected together as shown in FIGS. 3 and 4, the housing 37 defines a cavity 80 between portions of the housing component 38 and portions of the housing component 40. The mating portions 28 of the electrical conductors 18 are held within the cavity 80 along the lead retention area 54. In the exemplary embodiment, a recess 82 is formed within the surface 50 of the housing component 40. The recess 82 defines the cavity 80 and receives the mating portions 28 of the electrical conductors 18 therein. In the exemplary embodiment, the recess 82 also receives a portion of each electrical lead 16 that includes the electrically insulative jacket 24, as can be seen in FIG. 3. Alternatively, only the mating portions 28 of the electrical conductors 18 are held between the housing component 38 and the housing component 40 (and within the cavity 80 and the recess 82). In the exemplary embodiment, the housing component 40 includes only a single recess 82 for receiving each of the mating portions 28 (and in the exemplary embodiment a portion of the ribbon cable 10 having the electrically insulative jacket 24). Alternatively, the housing component 40 may include a plurality of recesses (whether or not each of the recesses is separate or interconnected to some or all of the other recesses) that each receives a corresponding one of the mating portions 28 therein. In addition or alternative to the recess 82, the housing component 38 may include one or more recesses (not shown).

The housing component 40 includes a plurality of holes 84 that extend therethrough. The housing component 40 may be referred to herein as defining a wall of the housing 37 through which the holes 84 extend. The holes 84 are positioned on the housing component 40 such that when the housing component 40 is connected to the housing component 38, the holes 84 are positioned along the lead retention area 54 to expose the mating portion 28 of a corresponding one of the electrical leads 16, or more specifically a corresponding one of the electrical conductors 18. A hole 85 is positioned to expose the ground strap 25. The hole 85 may optionally not be included if the ground strap 25 is not included. Moreover, more than one hole 85, or a larger and/or differently shaped hole 85, may optionally be provided to engage the ground strap 25 at multiple points. Although in the exemplary embodiment each hole 84 exposes a single corresponding mating portion 28, some or all of the holes 84 may alternatively be sized, shaped, and positioned to expose more than one mating portion 28. Although six holes 84 are shown, the housing 37 may include any number of holes 84 for each exposing any number of mating portions 28 (and any number of holes 85 for exposing any number of engagement points of the ground strap 25) and for exposing any number of mating portions 28 overall. Moreover, although each of the holes 84 and 85 are shown as being an elongate slot, each hole 84 and 85 may have any other suitable shape, size, and/or the like that enables the holes 84 and 85 to function as described herein. As will be described below, the exposed mating portions 28 are configured to directly engage, through the corresponding hole 84, a corresponding electrical contact (such as, but not limited to, a corresponding one of the electrical contacts 86 (shown in FIG. 8) of another connector (such as, but not limited to, the connector 78 shown in FIGS. 8 and 9).

The housing 37 may optionally include a latch component for latching the connector 34 to the other connector that the connector 34 mates with. In the exemplary embodiment, the latch component is a pair of openings 88 that each extend through both the housing component 38 and the housing component 40. As will be described below, the openings 88 each cooperate with a corresponding extension (such as, but not limited to, the extensions 90 shown in FIGS. 8 and 9) of the other connector that the connector 34 mates with. Although two openings 88 are shown, the housing 37 may include any number of openings 88 for cooperating with any number of extensions. Moreover, the housing 37 may have any other suitable type of latch components in addition or alternative to the opening(s) 88, such as, but not limited to, one or more extensions (not shown) that cooperate with one or more openings of the other connector that the connector 34 mates with and/or the like.

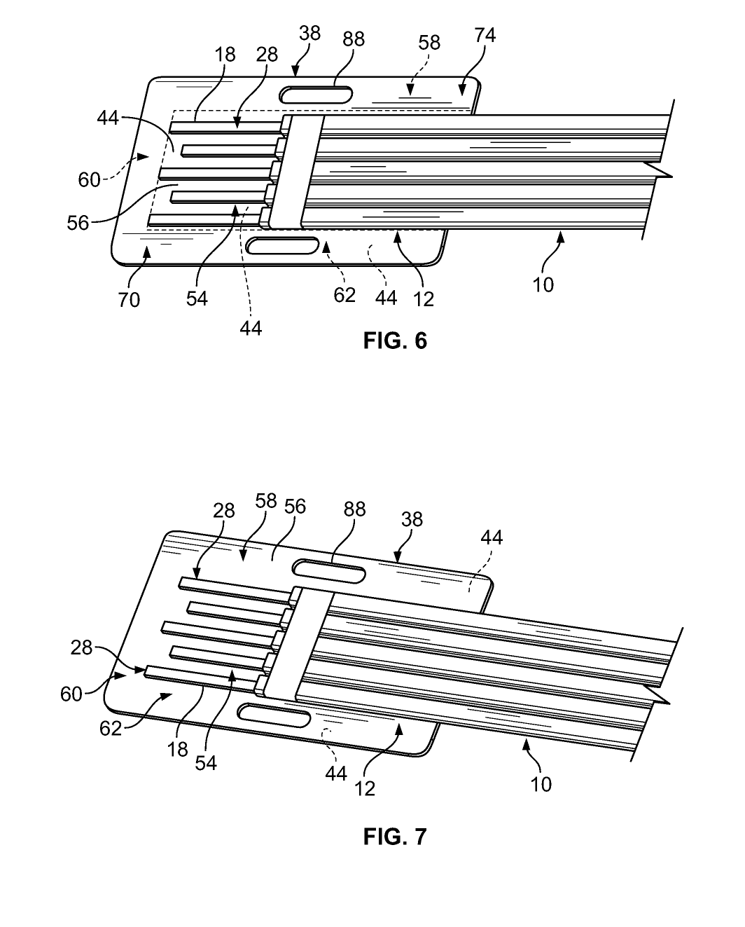

Referring now to FIGS. 3-7, the connector 34 is assembled and connected to the end portion 12 of the ribbon cable 10 by removing the portion 73 of the liner 70 from the surface 44 of the housing component 38. As shown in FIG. 6, the end portion 12 of the ribbon cable 10 is positioned on the surface 44 such that the mating portions 28 of the electrical conductors 18 are arranged on the lead retention area 54. The mating portions 28 are held on the lead retention area 54 via engagement with the adhesive 56. The portion 74 of the liner 70 is removed from the surface 44 of the housing component 38 to expose the adhesive 56 that extends along the edge portions 58, 60, and 62 of the surface 44, as is shown in FIG. 7. The portion 74 of the liner 70 may optionally be removed before arranging the mating portions 28 on the lead retention area 54. The housing component 40 is connected with the housing component 38 such that the surface 50 engages the adhesive 56 on the surface 44, to thereby hold the housing component 40 on the housing component 38. When assembled as described above and as shown in FIG. 3, the mating portions 28 of the electrical conductors 18 are held within the cavity 80 defined between the housing component 40 and the housing component 38. The holes 84 expose the mating portions 28 of the electrical leads 16 such that each of the exposed mating portions 28 can be directly engaged with a corresponding electrical contact (such as, but not limited to, a corresponding one of the electrical contacts 86 shown in FIG. 8) of another connector (such as, but not limited to, the connector 78 shown in FIGS. 8 and 9).

The ribbon cable 10 and the connector 34 may be sold or supplied to another party together, whether the connector 34 is supplied or sold as assembled and connected to the ribbon cable 10. Alternatively, the connector 34 may be supplied or sold to another party without the ribbon cable 10. In some embodiments, the connector 34 may be reusable with different ribbon cables 10. In other embodiments, once a ribbon cable 10 is connected to the connector 34, the connector 34 is not intended to be reusable with another ribbon cable 10.

Although the housing component 38 and the housing component 40 are shown as separate components that are connected together, the housing component 38 and the housing component 40 may alternatively be integrally formed. For example, in some the embodiments, the housing component 38 and the housing component 40 may be interconnected by a living hinge (not shown) before assembly and connection with the ribbon cable 10, wherein during assembly and connection of the connector 34 with the ribbon cable 10 the hinge is closed to bring the surface 44 and the surface 50 toward and into engagement with one another to define the cavity 80 and hold the mating portions 28 therein. Another example includes forming the housing component 38 and the housing component 40 as they are shown assembled in FIGS. 3 and 4, wherein to connect the ribbon cable 10 to the housing 37 the mating portions 28 are inserted into the cavity 80 and held along the lead retention area 54 via a fastener, such as, but not limited to, the adhesive 56, crimping the housing 37 around the mating portions 28, and/or the like.

FIG. 8 is an exploded perspective view of an exemplary embodiment of the connector 78 that is configured to be mated with the connector assembly 36 (FIGS. 3, 4, and 9). The connector 78 may be referred to herein as a “second connector”. The connector 78 includes a housing 92 and a boot 94 that surrounds at least a portion of the housing 92. The housing 92 includes a pair of clamshells 96 and 98 that are connectable together to define a cavity 100. The housing 92 holds a latch component 102 and a printed circuit board 104 within the cavity 100. As will be described below, the housing 92 includes an opening 101 that communicates with the cavity 100 and is configured to receive at least a portion of the connector 34 (FIGS. 3-7 and 9) therethrough such that at least a portion of the connector 34 is held within the cavity 100 when the connectors 34 and 78 are mated together.

The printed circuit board 104 includes a plurality of the electrical contacts 86 extending along a surface 106 thereof. Each electrical contact 86 is electrically connected to a corresponding trace 108 (only some are shown) of the circuit board 104 that electrically connects each electrical contact 86 to a corresponding electrical conductor (not shown) within a cable 110 that has an end portion 111 held by the boot 94. The cable 110 is electrically connected to an electronic device that the ribbon cable 10 (FIGS. 1-4, 6, 7, and 9) is desired to be connected to. The printed circuit board 104 also includes an electrical contact 87 that extends along the surface 106 and is electrically connected to a corresponding trace (not shown) of the circuit board 104 that electrically connects the electrical contact 87 to a corresponding electrical conductor (not shown) within the cable 110. In the exemplary embodiment, each electrical contact 86 and 87 is a spring contact to facilitate preloading engagement between the electrical contacts 86 and 87 and the corresponding mating portion 28 (FIGS. 1, 3, 6, and 7) and ground strap 25 (FIGS. 1, 3, 6, and 7), respectively, as will be described below.

The latch component 102 latches the connector 34 to the connector 78. In the exemplary embodiment, the latch component 102 includes a plate 112 that is movable within the cavity along a latch axis 114. The plate 112 includes the pair of extensions 90 that cooperate with the openings 88 (FIGS. 3-7 and 9) within the connector 34, as will be described below. The plate 112 includes a button 115 that actuates movement of the plate 112 in a direction 116 along the latch axis 114. The button 115 is exposed through an opening 118 within the clamshell 96 and engages a button 120 on the boot 94 such that when the button 120 is pushed in the direction 116, the button 115 is moved in the direction 116 to thereby move the plate 112 in the direction 116 along the latch axis 114. The plate 112 is biased in a direction 122 along the latch axis 114 that is opposite the direction 116 using any suitable biasing mechanism 113, such as, but not limited to, a helical spring and/or the like. Although two extensions 90 are shown, the connector 78 may include any number of extensions 90 for cooperating with any number of openings 88. Moreover, the connector 78 may have any other suitable type of latch components in addition or alternative to the plate 112 and/or the extensions 90, such as, but not limited to, one or more openings (not shown; such as, but not limited to, within the plate 112) that cooperate with one or more extensions (not shown) of the other connector 34 and/or the like.

The plate 112 includes a plurality of openings 124 that each receive a portion of a corresponding one of the electrical contacts 86 such that the electrical contacts 86 extend along a surface 126 of the plate 112 for engagement with the mating portions 28 when the connectors 34 and 78 are mated together. The plate 112 also includes an opening 125 that receives a portion of the electrical contact 87 such that the electrical contact 87 extends along the surface 126 of the plate 112 for engagement with the ground strap 25 (FIGS. 1, 3, 6, and 7) when the connectors 34 and 78 are mated together.

The clamshells 96 and 98 of the housing 92 may be connected together using any suitable fastener. In the exemplary embodiment, the clamshell 98 includes a pair of extensions 128 that are each received within a corresponding opening 130 within the clamshell 96. Although two extensions 128 and two openings 130 are shown, the housing 92 may include any number of extensions 128 and any number of openings 130. Other examples of fasteners for connecting the clamshells 96 and 98 together include, but are not limited to, using an adhesive, providing an interference-fit between portions of the clamshells 96 and 98, and/or the like. In an alternative embodiment, the clamshells 96 and 98 may be integrally formed. For example, in some the embodiments, the clamshells 96 and 98 may be interconnected by a living hinge (not shown) before assembly, wherein during assembly the hinge is closed to bring the clamshells 96 and 98 together. Another example includes forming the clamshells 96 and 98 as they are shown assembled in FIG. 9.

FIG. 9 is a partially broken-away perspective view of a connector assembly 132 illustrating the connector 78 mated together with the connector assembly 36. To mate the connectors 34 and 78 together, the connector 34 is inserted into the cavity 100 of the housing 92 through the opening 101 such that the connector 34 is positioned between the plate 112 and the clamshell 96, and such that the surface 52 of the housing component 40 faces the surface 126 of the plate 112. As the connector 34 is inserted into the cavity 100, engagement between the housing component 40 and the extensions 90 of the plate 112 moves the plate 112 along the latch axis 114, and against the bias of the biasing member 113 (FIG. 8), in the direction 116. Once the electrical contacts 86 and 87 (FIG. 8) are aligned with the corresponding holes 84 and 85 (FIGS. 3 and 5), respectively, housing component 40 and the extensions 90 are aligned with the corresponding openings 88, the bias of the biasing member 113 moves the plate 112 in the direction 122 along the latch axis 114 until the extensions 90 are received within the corresponding openings 88 and the contacts 86 and 87 are received within the corresponding holes 84 and 85, respectively. Once received within the corresponding holes 84 and 85, each electrical contact 86 and 87 is directly engaged with the corresponding mating portion 28 (FIGS. 1, 3, 6, and 7) and ground strap 25 (FIGS. 1, 3, 6, and 7), respectively. In some embodiments, when received within the corresponding holes 84 and 85, the electrical contacts 86 and 87 may be deflected against bias to provide a preload between each electrical contact 86 and 87 and the corresponding mating portion 28 and ground strap 25, respectively. The mating portions 28 of the connector assembly 36 are thereby directly electrically connected to the corresponding electrical contact 86 of the connector 78. Similarly, the ground strap 25 is thereby directly electrically connected to the electrical contact 87 of the connector 78.

To unlatch the connectors 34 and 78, the button 120 is pushed in the direction 116 until the extensions 90 clear the corresponding openings 88. The connector 34 can then be removed from the cavity 100 of the connector 78.

The embodiments thus described provide a connector that may be less costly and/or more easily manufactured, assembled, and/or terminated to a ribbon cable than at least some known connectors.

Although the connector 78 is shown and described herein for mating with the connector assembly 36, the connector 78 may be used to mate with any other suitable type of connector assembly besides the connector assembly 36. Similarly, although the connector assembly 36 is shown and described herein for mating with the connector 78, the connector assembly 36 may be used to mate with any other suitable type of connector besides the connector 78.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the subject matter described and illustrated herein has been described in terms of various specific embodiments, those skilled in the art will recognize that the subject matter described and illustrated herein can be practiced with modification within the spirit and scope of the claims.

What is claimed is:

1. A connector for terminating a ribbon cable having a plurality of electrical leads, each electrical lead comprising a mating portion, said connector comprising:
a housing having a wall and a cavity, the housing being configured to hold the mating portion of each electrical lead within the cavity, the housing comprising a hole extending through the wall of the housing and communicating with the cavity, wherein the hole exposes the mating portion of at least one electrical lead through the wall.

2. The connector according to claim 1, wherein the housing comprises:
a first housing component; and
a second housing component connectable to the first housing component such that the mating portions of the electrical leads are held between the first and second housing components, the second housing component being connectable to the first housing component such that the cavity of the housing is defined between the first and second housing components, wherein at least one of the first and second housing components defines the wall and the hole extends through the wall.

3. The connector according to claim 2, wherein at least one of the first and second housing components comprises a fastener for connecting the first and second housing components together.

4. The connector according to claim 3, wherein the fastener comprises an adhesive.

5. The connector according to claim 2, wherein at least one of the first and second housing components comprises a recess for receiving a portion of at least one electrical lead therein.

6. The connector according to claim 1, wherein the housing comprises indicia thereon.

7. The connector according to claim 1, wherein each mating portion is configured to directly engage a corresponding electrical contact of another connector through the hole when the connector is mated with the other connector.

8. The connector according to claim 1, wherein the housing comprises a lead retention area and a fastener extending along at least a portion of the lead retention area, the fastener being configured to hold the mating portions of the electrical leads on the lead retention area.

9. The connector according to claim 8, wherein the fastener comprises an adhesive.

10. The connector according to claim 1, further comprising the ribbon cable.

11. The connector according to claim 10, wherein each electrical lead includes an electrical conductor and insulation surrounding the electrical conductor, a portion of each electrical lead that includes the surrounding insulation being held within the cavity of the housing.

12. The connector according to claim 10, wherein each electrical lead comprises an approximately planar electrical conductor.

13. The connector according to claim 10, wherein an end portion of each electrical lead includes the corresponding mating portion.

14. The connector according to claim 1, wherein the housing comprises a latch component.

15. A connector for mating with another connector that terminates a ribbon cable, wherein the ribbon cable has a plurality of electrical leads, each of the electrical leads comprising a mating portion, said connector comprising:
a housing having a cavity configured to receive at least a portion of the other connector therein, the housing holding a plurality of electrical contacts within the cavity, wherein the electrical contacts are each configured to directly engage a corresponding one of the mating portions of the electrical leads when the connector is mated with the other connector.

16. The connector according to claim 15, wherein the housing comprises a pair of clamshells connected together to define the cavity.

17. The connector according to claim 15, wherein the housing comprises a latch component.

18. The connector according to claim 17, wherein the latch component comprises a plate held within the cavity and movable along a latch axis.

19. The connector according to claim 17, wherein the electrical contacts comprise spring contacts.

20. A connector assembly comprising:
a ribbon cable having a plurality of electrical leads, each of the electrical leads comprising a mating portion;
a first connector comprising a first housing having a wall and a cavity, the first housing holding the mating portion of each electrical lead within the cavity, the first housing comprising a hole extending through the wall of the first housing and communicating with the cavity, wherein the hole exposes the mating portion of at least one electrical lead through the wall; and
a second connector mated together with the first connector and comprising a second housing holding a plurality of electrical contacts, wherein each of the mating portions of the electrical leads is directly engaged with a corresponding one of the electrical contacts of the second connector.
